(19) United States
(12) Patent Application Publication
(10) Pub. No.: US 2003/0161631 A1
(43) Pub. Date: Aug. 28, 2003

(54) Optical channel monitor device and method

(75) Inventor: Moti Margalit, Zichron Yaaqov (IL)

Correspondence Address: LADAS & PARRY, 26 WEST 61ST STREET, NEW YORK, NY, 10023, US

(73) Assignee: LAMBDA CROSSING LTD.

(21) Appl. No.: 10/318,333

(22) Filed: Dec. 12, 2002

Related U.S. Application Data
(60) Provisional application No. 60/339,335, filed on Dec. 13, 2001.

(51) Int. Cl. H04B 10/08

(52) U.S. Cl. 398/33; 398/25; 398/29

(57) ABSTRACT

An optical device and method are presented for use in monitoring at least one optical channel of an input multi-channel light signal. The device comprises a light splitting assembly for splitting the input light signal into a predetermined number of light components; a predetermined number of tunable wavelength-selective filters each for filtering light of a specific optical channel from the light component passing therethrough; and the predetermined number of receivers, each associated with the corresponding one of said filters and operating to detect the filtered light and generate an output signal indicative thereof The device thereby enables for processing the output signals by an electronic assembly to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

### FIELD OF THE INVENTION

This invention is generally in the field of optical devices for use in optical communication systems, and relates to an optical channel monitoring device and method.

### BACKGROUND OF THE INVENTION

Optical transmission systems, which are based on wavelength division multiplexing (WDM), achieve high information capacities by aggregating many optical channels onto a signal strand of optical fiber. As the number of channels increases, the network economics dictate less opacity, i.e. less conversion from the optical signal domain to the electronic signal domain. As a result, monitoring of the channel integrity and quality, which is typically conducted in the electronic domain, has to be executed at the optical level.

Generally, channel monitoring devices fall under one of the two following categories:

Devices utilizing a channel monitor that monitors the power and the central frequency of an optical channel. Channel monitors can provide alarms when the power level or central frequency deviates from predefined boundaries.

Devices utilizing a performance monitor that provides a quantitative assessment of the quality of an optical signal. The performance monitor can measure the optical signal to noise ratio (OSNR), or can examine the electronic counterpart of the optical signal, using either the eye pattern Q-factor or the bit error rate.

While the use of performance monitoring devices is the preferable solution, these devices are more expensive as a result of signal processing or high-speed electro-optics required to realize the device. Also, in most cases, the integration of complex tunable optical elements and high-speed electronics is problematic.

A channel monitoring technique typically requires extraction of the following salient optical features: absolute power of signal, relative power of signal, absolute frequency of signal, optical signal to noise ratio, signal eye pattern, signal bit error rate, polarization information for polarization mode dispersion (PMD) compensation. It is known to achieve the monitoring of an optical signal by utilizing a tunable filter and photo-detector (e.g., WO 01/67646, U.S. Pat. No. 6,310,703, WO 01/67658), or a wavelength splitting mechanism and an array of detectors (e.g., WO 99/34539). According to the technique of WO 01/67646, one scanning tunable filter and two detectors are utilized. The detectors concurrent information on two distinct frequency bands. Hence, their combined information does not provide for any improvement in the resulting monitoring function. According to the alternative approach of WO 99/34539, a grating based device is used that separates different channels to spaced-apart locations, which are then detected. While this technique makes use of multiple detectors, the information in the detectors is distinct, and one detector cannot be used to improve on the information in the other detectors. Additionally, these prior art solutions, while addressing some aspects of the above requirements, are incapable of addressing the full spectrum.

### SUMMARY OF THE INVENTION

There is accordingly a need in the art to facilitate channel monitoring by providing a novel optical device and method for use in monitoring optical channel(s) of a light signal.

The present invention provides for splitting at least a portion of a light signal to be monitored into at least two light components and passing each of these light components through a tunable wavelength-selective filter, which is associated with its own receiver (detector). In other words, a predetermined number of the light components of the input light signal are filtered by the corresponding number of tunable filters and the corresponding number of so-filtered light signals are detected by the corresponding number of receivers. Processing the detected light signals by an electronic assembly provides for determining at least one of the following: a central frequency of a specific optical channel of the input light signal, a power of a specific channel, a signal to noise ratio of the detected specific channel, eye pattern extraction; bit error rate extraction; relative timing jitter of orthogonal polarizations, and Polarization Mode Dispersion (PMD) of the light signal.

The filters may be configured to provide parallel or cascaded filtering of the split light components.

The light splitting assembly may be of any known kind capable of coupling light between two or more light channels. The light splitting assembly may include a wavelength selective filter. Examples of light splitting techniques suitable to be used in the present invention are described for example in the following publications: “A proposed Design for Ultralow-Los Waveguide Grating Routers”, Jerry C. Chen and Corrado Dragone, IEEE Photonics technology Letters, Vol. 10, No. 3, March 1998, pp. 379-381; “An Improved Single-Mode Y-Branch Design for Cascaded 1:2 Splitters”, A. Klekamp et al., Journal of Lightwave Technology, Vol. 14, No. 12, 1996, pp. 2684-2686; “Fabrication of 4×4 Tapered MMI Coupler with large Cross Section”, Hongzhen Wie, et al., IEEE Photonics technology Letters, Vol. 13, No. 5, May 2001, pp. 466-468; “Theory of Variable-Ratio Power Splitters Using Multimode Interference Couplers”, N. S. Lagali et al., IEEE Photonics technology Letters, Vol. 11, No. 6, June 1999, pp. 665-667. Another example of the light splitting assembly is that utilizing a so-called “star coupler”.

There is thus provided according to one aspect of the present invention, an optical device for use in a monitoring system for monitoring at least one optical channel of an input multi-channel light signal, the device comprising: a light splitting assembly for splitting the input light signal into a predetermined number of light components; a predetermined number of tunable wavelength-selective filters each for filtering light of a specific optical channel from the light component passing therethrough; and the predetermined number of receivers, each associated with the corresponding one of said filters and operating to detect the filtered light and generate an output signal indicative thereof; the device thereby enabling processing of the output signals by an electronic assembly to determine at least one of the following: central frequency of at least one optical channel of the input light signal, power of at least one optical channel of the input light signal, signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

The filters can be paired, such that the filters of each pair are tunable to the same optical channel and have spaced-apart central wavelengths. Each pair of filters with its corresponding pair of receivers thus present a so-called “wavelength discriminator unit”. This enables subtracting the output of one receiver of the discriminator unit from the output of the other receiver of said discriminator unit, thereby providing for frequency, power and signal to noise measurements with enhanced accuracy

The light splitting assembly may include a polarization splitter. In this case, at least one pair of filters tunable to the same optical channel and optimized for processing light of different linear polarizations, respectively, can be used. If a single pair of filters is used, by retuning this pair of filters from channel to channel, multiple optical channels of the input light can be monitored. Two pairs of filters can be used, wherein the filters of one pair are optimized to the same linear polarization different from that of the other pair of filters. The light splitting assembly thus comprises a polarization splitting arrangement and a power splitting arrangement. For example, two power splitters are accommodated downstream of a single polarization splitter, each power splitter thereby splitting each of two orthgonally polarized light portions of the input light into a pair of spatially separated light components to propagate to the corresponding pair of filters. Alternatively, two polarization splitters are accommodated downstream of a single power splitter, each of the polarization splitters thereby splitting a corresponding one of the light portions resulting from the power splitting of the input light into a pair of orthgonally polarized light components to propagate to the corresponding pair of filters. In these configurations, the filters can also be paired to form with their corresponding receivers one or more discriminator units

The device of the present invention may comprise an array of N filters and an array of N receivers, each receiver associated with a corresponding one of the filters. The filters may be tuned to N different channels, respectively, of the input multi-channel light signal. The N filters and N receivers may present an array of N/2 discriminator units, for example for monitoring N/2 optical channels of the multi-channel input light signal. The N filters may be of two groups: N/2 filters of the first group optimized for processing light of one linear polarization, and N/2 filters of the second group for processing light of the other linear polarization. The N/2 filters of each group may also be paired as described above to form, with their corresponding receivers, N/4 discriminator units.

The filter may be constructed in a conventional manner, for example including at least one of the following known structures: a tunable ring resonator based filter, a tunable fiber Bragg grating, a tunable micromechanical optical filter, a tunable Fabri-Perot, a tunable thin film filter.

According to another broad aspect of the present invention, there is provided an optical device for use in a monitoring system for monitoring at least one optical channel of an input multi-channel light signal, the device comprising:

a light splitting assembly for splitting the input light signal into at least one pair of light components;

at least one pair of tunable wavelength-selective filters, the paired filters being tunable for the same optical channel, for filtering light of said optical channel from the light components passing therethrough, and having spaced-apart central wavelengths;

at least one pair of receivers, each receiver being associated with the corresponding one of the filters and operating to detect the filtered light and generate an output signal indicative thereof;

the device thereby enabling processing of the output signals by an electronic assembly by subtracting for each pair of receivers, the output signal of one receiver from that of the other receiver of said pair, to determine at least one of the following: central frequency of the filtered optical channel, power of the filtered optical channel, signal to noise ratio of the detected optical channel, eye pattern within said optical channel; bit error rate extraction; relative timing jitter of orthogonal polarizations of the filtered optical channel, and Polarization Mode Dispersion (PMD) of the filtered optical channel.

According to yet another broad aspect of the present invention, there is provided an optical device for use in a monitoring system for monitoring at least one optical channel of an input multi-channel light signal, the device comprising:

a light splitting assembly including a polarization splitting arrangement and a power splitting arrangement operating together to split the input light signal into a predetermined number of spatially separated light components, forming the light components of a first group having one linear polarization and the light components of a second group having the other linear polarization;

the predetermined number of tunable wavelength-selective filters each for filtering light of a specific optical channel from the light component passing therethrough, said filters comprising the filters of a first group optimized for processing light of one linear polarization, and the filters of a second group optimized for processing light of the other linear polarization; and

the predetermined number of receivers, each associated with the corresponding one of said filters and operating to detect the filtered light and generate an output signal indicative thereof;

the device thereby enabling processing of the output signals by an electronic assembly to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

According to yet another aspect of the present invention, there is provided an optical device for use in a monitoring system for monitoring at least one optical channel of an input multi-channel light signal, the device comprising:

a light splitting assembly comprising a polarization splitter for splitting the input randomly polarized light signal into two light components of orthogonal polarizations, respectively;

two tunable wavelength-selective filters optimized for processing light of different linear polarizations, respectively, and tunable for the same optical channel of the input light signal for filtering light of said optical channel from the light components passing therethrough, respectively;

two receivers, each associated with the corresponding one of said filters and operating to detect the filtered light and generate an output signal indicative thereof; the device thereby enabling monitoring of multiple channels of the input light signal by retuning the filters from channel to channel, and enabling processing of the output signals by an electronic assembly to determine at least one of the following: central frequency of the filtered optical channel, power of the filtered optical channel, a signal to noise ratio of the detected optical channel, eye pattern within the filtered optical channel; bit error rate extraction; relative timing jitter of orthogonal polarizations of the filtered light channel, and Polarization Mode Dispersion (PMD) of the filtered optical channel.

According to yet another aspect of the present invention, there is provided an optical device for use in a monitoring system for monitoring at least one optical channel of an input multi-channel light signal, the device comprising:

a light splitting assembly comprising a polarization splitting arrangement and a power splitting arrangement operating together to split the input light signal into two pairs of spatially separated light components;

two wavelength discriminator units, each wavelength discriminator unit comprising a pair of tunable wavelength-selective filters each for filtering light of a specific optical channel to which the filter is tuned from the light component passing therethrough, and comprising a pair of receivers associated with said pair of filters, respectively, and operating to detect the filtered light and generate two output signal indicative thereof, all the filters being tunable to the same optical channel, such that the filters of each pair have spaced-apart central wavelengths; the device thereby enabling processing of the output signals by an electronic assembly to determine at least one of the following: a central frequency of the optical channel to which the filters are tuned, a power of said optical channel, a signal to noise ratio of the detected optical channel, eye pattern within said optical channel; bit error rate extraction; relative timing jitter of orthogonal polarizations of said light channel, and Polarization Mode Dispersion (PMD) of said optical channel.

According to yet another aspect of the invention, there is provided an optical device for use in a monitoring system for monitoring N optical channels of an input multi-channel light signal, the device comprising:

a light splitting assembly comprising polarization splitting arrangement and a power splitting arrangement operating together to split the input light signal into 2N spatially-separated light components including N light components of a first group having one linear polarization and N light components of a second group having the other linear polarization;

an array of N wavelength discriminator units for processing said N optical channels, respectively, each wavelength discriminator unit comprising: a pair of tunable wavelength-selective filters each for filtering, from the light component passing therethrough, light of a specific optical channel different from those of the other channels, the filters of each pair having spaced-apart central wavelengths, and comprising a pair receivers associated with said pair of filters, respectively, and operating to detect the filtered light and generate two output signal indicative thereof;

the device thereby enabling processing of the output signals by an electronic assembly to subtract the output of one receiver of the discriminator unit from the output of the other receiver of said discriminator unit, and obtain data indicative of at least one of the following: central frequency of each of the N optical channels, a power of each of the N optical channels, a signal to noise ratio in each of the detected optical channels, eye pattern within each of the N optical channels; bit error rate extraction; relative timing jitter of orthogonal polarizations of each of the N optical channels, and Polarization Mode Dispersion (PMD) of each of the N optical channels.

The present invention, according to its yet another broad aspect, provides a method for use in monitoring at least one optical channel of an input multi-channel light signal, the method comprising:

(i) splitting the input light signal into a predetermined number of light components;

(ii) passing the light components through the predetermined number of tunable wavelength-selective filters, respectively, to thereby filter from each of the light components a light signal of a specific optical channel;

(iii) detecting the filtered light signals by the predetermined number of receivers, respectively, to thereby generate the predetermined number of output signal indicative of the detected light signals;

the method thereby enabling processing the output signals by an electronic assembly to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 schematically illustrates an optical device according to one embodiment of the invention utilizing an array of two tunable wavelength-selective filters and an array of two light receivers;

FIG. 2 graphically illustrates the principles of a wavelength discriminator circuit that can be used in the device of FIG. 1;

FIG. 3 exemplifies an optical device according to another embodiment of the invention utilizing cascaded receivers;

FIG. 4 exemplifies an optical device according to yet another embodiment of the invention utilizing a wavelength discriminator circuit;

FIG. 5 illustrates a system for monitoring a multi-channel light signal utilizing an optical device according to the invention composed of an array of filters and receivers, that may and may not be arranged in the discriminator wavelength circuit;

FIG. 6 illustrates the output of a wavelength-selective filter as a function of frequency describing the critical features characterizing the filter;

FIG. 7 shows the OSNR as a function of the filter width, noise floor, and number of optical channels;

FIG. 8 shows the OSNR obtained with the wavelength discriminator circuit compared to that of a standard filter device; and

FIG. 9 compares the correlation function of the discriminator unit with that of standard filters of different bandwidths.

### DETAILED DESCRIPTION OF THE INVENTION

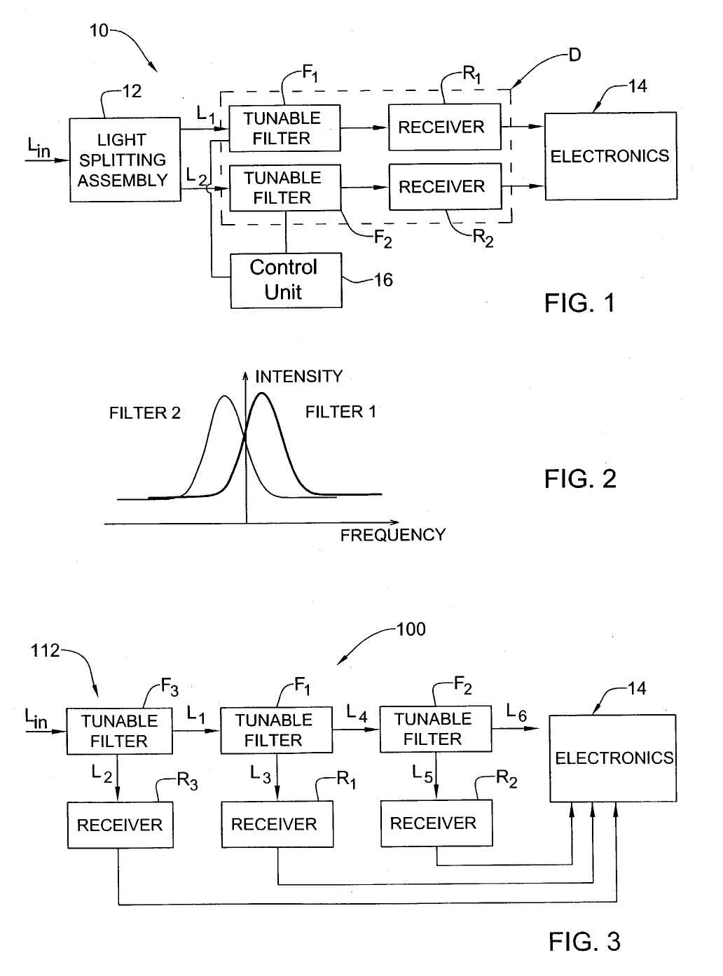

Referring to FIG. 1, there is exemplified an optical device 10 according to one embodiment of the invention for monitoring an input light signal Lᵢₙ. The device 10 includes a light splitting assembly 12; an array of a predetermined number of tunable frequency-selective filters—two such F₁ and F₂ in the present example; and an array of the corresponding number of receivers—two R₁ and R₂ in the present example associated with the filters F₁ and F₂, respectively. The light splitting assembly 12 splits the input light Lᵢₙ into a pair of light components L₁ and L₂, which pass through the filters F₁ and F₂, respectively. Each of the filters F₁ and F₂ separates from the corresponding light component a light signal of an optical channel to which the filter it tuned, and the filtered light signal is detected by the corresponding receiver. Electrical outputs of the receivers are transmitted to an electronic assembly 14, which processes these output signals to determine at least one parameter of the input light signal, as will be described further below. Further provided is a control unit 16 for tuning the optical channel of each of the filters. A tuning mechanism may be based on changing the optical path length by the thermo-optic effect and local heating, the electro-optic effect, a mechanical effect by either one of these effects or by the piezo effect.

By retuning each of the filters from channel to channel, multiple channels of the input light can be scanned. Each filter-receiver pair can be used for determining at least one of such parameters of the filtered optical channel as power, center frequency, and OSNR. By providing an array of filter-receiver pairs, multiple channels of the input light can be concurrently monitored.

In the configuration of FIG. 1, the filters F₁ and F₂ can be tuned to the same optical channel, and optimized for different linear polarizations. In this case, the light splitting assembly 12 is a polarization splitter that splits the input light Lᵢₙ to the light components L₁ and L₂ of the orthogonal polarizations, respectively. The parameters of the filtered optical channel that can be derived in this case are the same as above, i.e., power center frequency, and OSNR, and additionally, the electronic data in both polarizations can be measured. Comparison of the power in the polarizations provides information on the polarization dependant loss of the system, knowledge of the center frequency dependant shift, the signal to noise ratio between different polarizations, which can provide feedback in regards to noise sources or potential source problems in the system, and comparison of the electronic signal between polarization provides information about the polarization mode dispersion.

In the configuration of FIG. 1, the device 10 can present a wavelength discriminator circuit. To this end, the pair of filters F₁ and F₂ are tunable to the same optical channel with spaced-apart central wavelengths of the filters (the spacing being less that the bandwidth of the filter). This is illustrated in FIG. 2: the paired filters F₁ and F₂ of the discriminator unit are tuned to the same optical channel and have central wavelengths spaced by a few GHz. The pair of filters F₁ and F₂ with the pair of receivers R₁ and R₂, respectively, present a discriminator unit D, as shown in FIG. 1 in dashed lines. The light splitting assembly 12 is thus a power splitter that splits the input light signal Lᵢₙ in two light components L₁ and L₂ (generally, into a corresponding number of pairs of light components corresponding to the number of filter pairs in the device). Each discriminator unit determines the same parameters as a single filter-receiver pair (e.g., power of the filtered optical channel, center frequency of this channel, and OSNR). The use of a wavelength discriminator provides for enhanced accuracy in power and frequency measurement, as well as higher dynamic range of OSNR measurement, by virtue of the two filters and signal processing, as will be described further below.

FIG. 3 exemplifies an optical device 100 according to yet another embodiment of the invention. The same reference numbers are used for identifying components that are common in al the examples of the invention. In the example of FIG. 3, a light splitting assembly 112 includes a tunable wavelength-selective filter F₃, and all the filters F₁, F₂ and F₃ are arranged in the cascaded manner. The filters F₁, F₂ and F₃ are associated with their respective receivers R₁, R₂ and R₃. It should be noted that the filters can be tuned to different optical channels, or alternatively, at least two of these filters can be tuned to the same optical channel, thereby carrying out the so-called double-stage filtering of the same optical channel. The filter F₃ receives the input light signal Lᵢₙ and, while separating (filtering) therefrom a specific optical channel, splits the input light signal Lᵢₙ into a light component L₁ (of the filtered channel) and a light component L₂ (of all other channels of the input light). These split light components L₁ and L₂ are collected at, respectively, the receiver R₁ and the next filter F₂ in the filter array. The light component L₂ is then filtered by filter F₂, and a separated light component L₃ of a specific filtered channel is collected by the receiver R₂, and a light component L₄ containing the remaining optical channels passes through the filter F₃. The latter in turn processes the light component L₄ by separating therefrom a light component L₅ of a specific channel, while allowing the remaining portion L₆ of the light component L₄ to propagate to a further filter, as the case may be. Each filter-receiver pair can determine the power of the filtered optical channel, the center frequency of this channel, and intra-channel (between channels) OSNR.

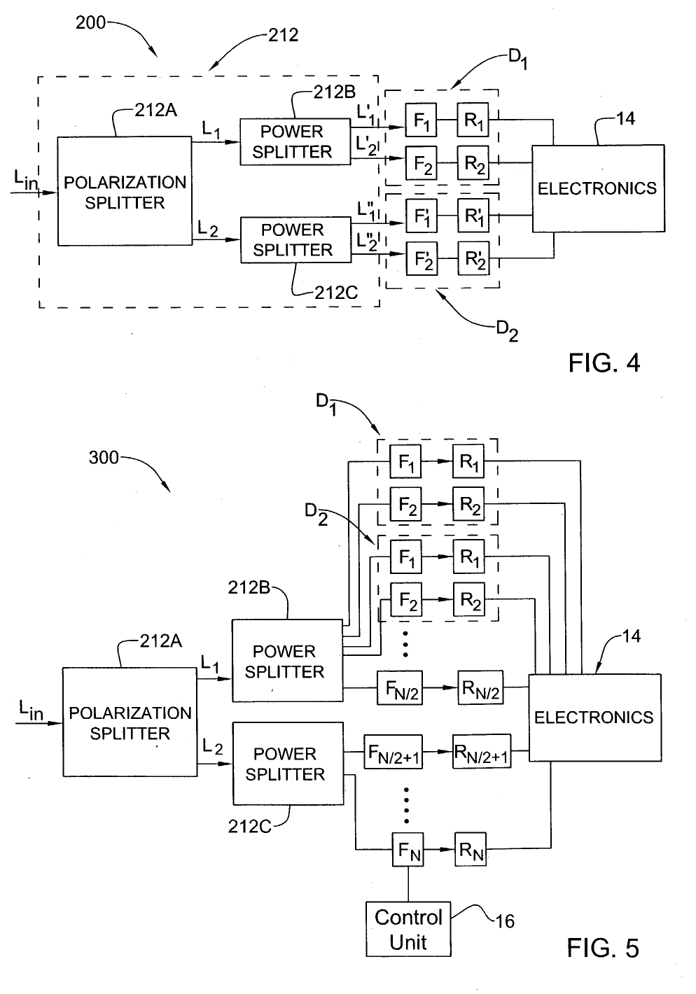

FIG. 4 exemplifies an optical device 200 according to yet another embodiment of the invention utilizing the wavelength discriminator circuit. The device 200 includes a light splitting assembly 212 and two discriminator units D₁ and D₂. The unit D₁ is composed of a first pair of tunable frequency-selective filters F₁ and F₂ and a first pair of receivers R₁ and R₂ associated with the filters F₁ and F₂, respectively, and the unit D₂ is composed of a second pair of tunable filters F′₁ and F′₂ and a second pair of receivers R′₁ and R′₂ associated with the filters F′₁ and F′₂, respectively. The filter pairs F₁-F₂ and F′₁-F′₂ are optimized for processing light of orthogonal polarizations, respectively, and are tuned to the same optical channel, the filters of each pair having spaced-apart central wavelengths. Outputs of all the receivers are transmitted to the electronic assembly 14.

The light splitting assembly comprises a polarization splitting arrangement and a power splitting arrangement. In the present example of FIG. 4, the polarization splitting arrangement is accommodated upstream of the power splitting arrangement with respect to the direction of input light propagation to the device 200. In other words, power splitting is applied to split polarization portions of the input light signal. Consequently, the polarization splitting arrangement includes a single polarization splitter 212A that splits an input multi-channel randomly polarized light signal Lᵢₙ into two light portions L₁ and L₂ of the orthogonal polarizations, and the power splitting arrangement includes two power splitters 212B and 212C each for splitting a corresponding one of the polarized light portions L₁ and L₂. It should be understood, although not specifically shown, that the construction can be such that polarization splitting is applied to light portions resulting from the power splitting of the input light. Accordingly, the element 112A will constitute a power splitter, and elements 112B and 112C will constitute two polarization splitters.

The device 200 operates in the following manner. The polarization splitter 212A splits input multi-channel randomly polarized light Lᵢₙ into two light portions L₁ and L₂ of the orthogonal polarizations. The power splitter 212B then splits the light portion L₁ into light components L′₁ and L″₁ (e.g., of substantially equal power) and directs them to the filters F₁ and F_{2,} respectively, and the power splitter 212C equally splits the light portion L₂ into light components L′₂ and L“₂ to be processed by the filters F′₁, and F′₂, respectively. Electrical outputs of the receivers R₁-R₂ and R′₁-R′₂ are then processed by the electronic assembly 14 to determine the characteristics of the orthogonal polarizations of the specific optical channel by subtracting for each receiver pair the output of one receiver from that of the other. Data signal resulting from the subtraction is indicative of the signal integrity and relative delay between the polarization split portions, thereby enabling measuring Polarization Mode Dispersion of the light signal.

FIG. 5 illustrates a system for monitoring a multi-channel optical signal Lᵢₙ utilizing an optical device 300 according to yet another example of the present invention designed to be capable of concurrent filtering multiple optical channels. The optical device 300 thus comprises a light splitting assembly 212; an array of N filters; and an array of N receivers associated with said N filters, respectively. Outputs of all the receivers are connectable to an electronic assembly 14. A control unit 16 serves for tuning the optical channels of the filters. In the present example, the light splitting assembly 212 comprises a polarization splitter 212A that splits input light Lᵢₙ into two light portions L₁ and L₂ of orthogonal polarizations and two power splitters 212B and 212C that split the light portions L₁ and L₂, respectively, into two groups of light components: N/2 light components propagating towards N/2 filters F₁-F_{N/2}, and N/2 light components propagating towards filters F_{(N/2+1)}-F_{N}. The filters F₁-F_{N/2} of the first group are optimized for processing light of one linear polarization, and the filters of F_{(N/2+1)}-F_{N} of the second group are optimized for processing light of the other linear polarization. The filters of each group can be tuned for different N/2 optical channels, thereby allowing for concurrent monitoring of multiple channels of the input light signal.

As shown in FIG. 5 in dashed lines, the filter-receiver assemblies can be paired to define N/2 discriminator units D₁-D_{N/2}: discriminator unit D₁ formed by the filter pair F₁-F₂ and receiver pair R₁-R₂, discriminator unit D₂ formed by filter pair F₃-F₄ and receiver pair R₃-R₄, and so on. The two filters of the discriminator unit are tuned to the same channel (wavelength), and the central wavelength of one filter is spaced-apart from the central wavelength of the other filter. Generally, each wavelength discriminator unit in the array can serve for monitoring a specific optical channel of the input light signal different from those of the other discriminator units.

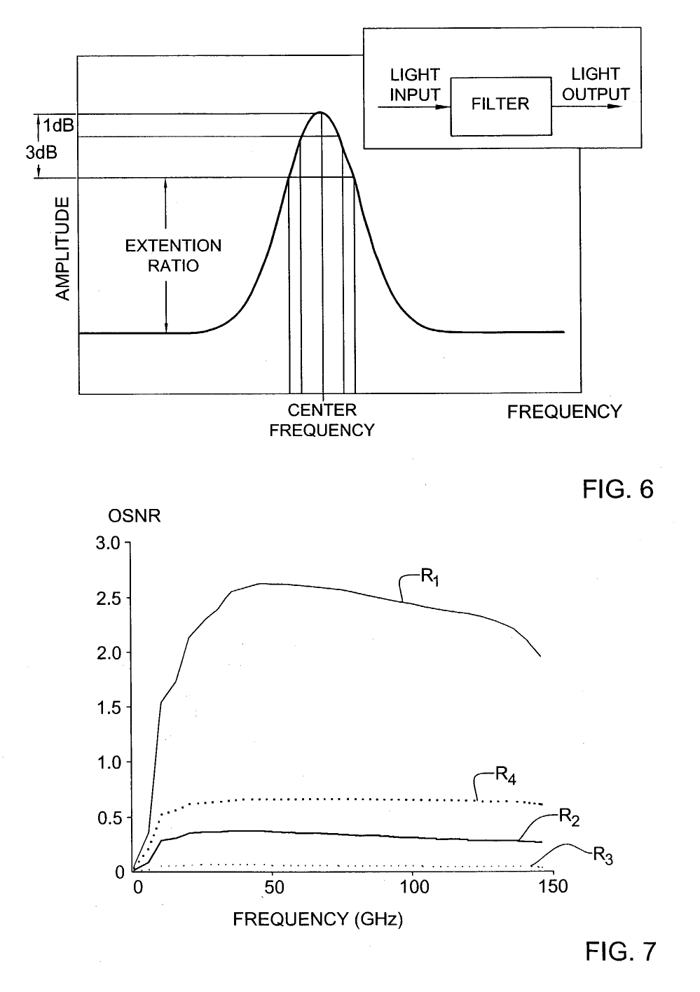

Generally speaking, the present invention makes use of tunable optical filters to interrogate the optical spectrum and extract meaningful communication parameters. To better understand the role of the filter, several filter configurations are examined. A schematic filter configuration is shown in the inset of FIG. 6. The filter means is associated with an input light-path, and an output light-path, and can be a Fabri-Perot (FP), thin film filter (TFF), fiber Bragg grating (FBG), ring resonator (RR) or a combination of multiple ring resonators (MRR). The construction and operation of all these filter structures are known per se and therefore need not be specifically described, except to note the following. Despite the different technologies, the filters have common critical features:

Insertion loss—the amount of power loss the light suffers as it transverses the filter;

Central frequency—the frequency of the center of the filter;

1 dB bandwidth—the frequency difference from the central frequency at which the amplitude of the filter drops by 1 dB;

3 dB bandwidth—the frequency difference from the central frequency at which the amplitude of the filter drops by 3 dB; and

Extinction ratio—the amount of attenuation incurred by out of band optical signals.

The general practice involves the use of narrow filters to extract the frequency related parameters such as the central frequency or 1 dB drop. A high extinction ratio is obtained by cascading two filters in serial (as shown in FIG. 3), and short scan times are obtained by using parallel filters in a grating based approach (as shown in FIG. 5).

While narrow filters appear to provide better wavelength resolution, they suffer from an inherent disadvantage in optical signal to noise (OSNR). The optical signal to be measured is always embedded in additional signals and random noise. In general, all the signals outside the filter bandwidth form a base line noise floor to the optical signal to be measured. The OSNR value is given by:

$${OSNR}_{i} = \frac{{S}_{i}}{N + {\sum }_{j \neq i} {S}_{j}} \qquad ( 1 )$$

where Sₗ is the optical signal to which the filter is tuned, Sⱼ are the rest of the optical signals in the channel, and N is the optical noise in the channel caused by the amplified spontaneous emission of the optical amplifiers. The power of each signal is provided by integrating their spectral content and the filter shape:

$${S}_{m} = {\int }_{λ}^{} {S}_{m} ( λ ) F ( λ ) ⅆ λ \qquad ( 2 )$$

where Sₘ is any of the channels Sⱼ or the optical noise N.

The optical noise N is assumed to be constant across the wavelength range λ.

FIG. 7 illustrates the OSNR as a function of the filter 3 dB bandwidth, for four cases:

Graph R₁—corresponds to a 16 channel system, each channel having a power of 0 dBm (1 mW) and the ASE integrated noise of 0 dBm;

Graph R₂—16 channel system, each channel having a power of 0 dBm (1 mW) and the ASE integrated noise of 10 dBm;

Graph R₃—16 channel system, each channel having a power of 0 dBm (1 mW) and the ASE integrated noise of 20 dBm;

Graph R₄—40 channel system, each channel having a power of 0 dBm (1 mW) and the ASE integrated noise of 0 dBm.

It is clear from FIG. 7 that the filter should be wider than the bandwidth of the optical signal, to provide for optimal signal to noise ratio. While it is well known that the ideal filter for extraction of a signal from noise is a matched filter, it is problematic to use such a filter in an optical monitor system, where maximum resolution obtained by narrow filters does not correlate with the optimal signal to noise.

As indicated above with reference to FIGS. 1 and 2, the present invention provides for accurate wavelength measurement by using the wavelength discriminator circuit. The input optical power Lᵢₙ is thus split between two tunable filters F₁ and F₂ and subsequent receivers R₁ and R₂. The measurement of the optical power at the receivers can be pre-calibrated to compensate for possible manufacturing inaccuracies in the split and detect system. The receivers have a narrow bandwidth (several tens of MHz), compared to the optical bandwidth (several GHz). Hence, the receivers act as averaging elements, which provide the optical power as defined in equation (2) above. The optical power reading from both receivers (detectors) is then subtracted in the electronic assembly. When the two filters of the discriminator unit are spaced apart in frequency, the result provides a frequency differentiator function with much reduced optical noise.

The following is a more detailed analysis of the discriminator unit operation:

The filters of the discriminator unit are spaced apart by a few GHz. Hence, the power in each filter can be written as,

$${P}_{i} = {a}_{i} {\int }_{λ}^{} {\sum }_{j} ( {S}_{j} + N ) {F}_{i} ( λ ) ⅆ λ \qquad ( 3 )$$

wherein i=1,2 for either of the filters, and the power components Pᵢ are normalized so that, when they are at the same frequency, the power reading in both is the same. This normalization is critical in obtaining an enhancement in the signal to noise ratio. Subtracting P₁ from P₂ results in:

$$Δ = {a}_{1} {P}_{1} - {a}_{2} {P}_{2} = {\int }_{λ}^{} {\sum }_{j} ( {S}_{j} + N ) ( {a}_{1} {F}_{1} ( λ ) - {a}_{2} {F}_{2} ( λ ) ) ⅆ λ \qquad ( 4 )$$

The OSNR can now be determined from the above equations (1) and (4) as follows:

$${OSNR}_{i} = \frac{{\int }_{λ}^{} {S}_{i} ( {a}_{1} {F}_{1} ( λ ) - {a}_{2} {F}_{2} ( λ ) ) ⅆ λ}{{\int }_{j \neq i}^{} {\sum }_{j} ( {S}_{j} + N ) ( {a}_{1} {F}_{1} ( λ ) - {a}_{2} {F}_{2} ( λ ) ) ⅆ λ} \qquad ( 5 )$$

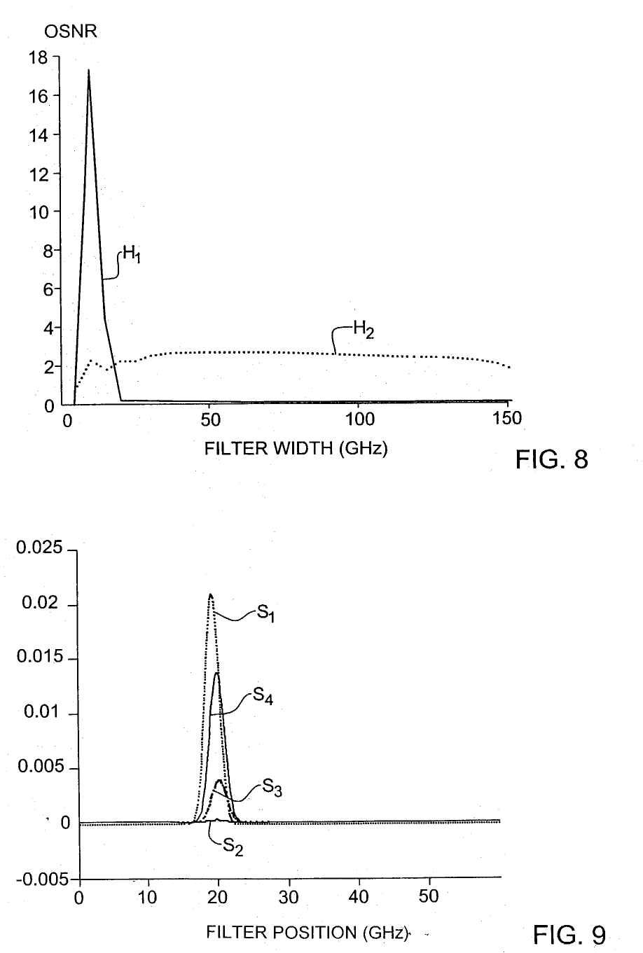

FIG. 8 illustrates the OSNR of the discriminator circuit (determined from equation (5) above) as a function of the filter bandwidth GHz—graph H₁, as compared to that of a standard filter—graph H₂, with the optimal bandwidth for all the above signal scenarios. In FIG. 9, the correlation function of the filter with the signal is shown for the conventional optical filters with different filter bandwidths 1 GHz, 5 GHz, and 10 GHz—graphs S₂, S₃ and S₄, respectively, and for the wavelength discriminator circuit of the present invention—graph S₁. The correlation function is that function detected by the receiver when the filter is swept across the signal. The peak of the correlation function corresponds to the center frequency of the detected signal. The sharper the function peak, the better the resolution of the wavelength. A wide correlation can easily be corrupted by noise making it difficult to find its peak intensity. As evident from FIGS. 8 and 9, the device of the present invention provides for enhanced resolution with better OSNR.

Turning back to FIG. 5, multiple filters can be functionally paired off to form frequency discriminator units, each unit providing for high resolution of the detected optical spectrum. By using multiple parallel filter sets, scan time can be reduced as the scan is divided between the filters.

The use of the optical device in the form of a wavelength discriminator circuit provides for the accurate determination of the wavelength and power of the optical signal. The same filters which perform the discrimination function can be used in a different context to filter out a specific channel to thereby enable detection of the remaining channel(s) by a high-speed receiver. This provides for simultaneous electronic detection of the signal with high-resolution detection of the center frequency of the signal. The detected electronic signal can be used to characterize the electronic eye pattern which is indicative of the quality of the signal, and/or measure the bit error rate of the signal using either a predetermined binary sequence or a convolution error correction scheme, such as forward error correction.

By separating the two polarization components at the input, such an important function as polarization analysis can be obtained. This is critical for PMD compensation techniques, where the relative status of each polarization is analyzed. PMD measurement can be done directly in the optical domain by doing time delayed interferometry measurements or, preferably, in the electronic domain where the time correlated electronic signal is used to determine the relative delay between the two polarizations.

Those skilled in the art will readily appreciate that various modifications and changes can be applied to the embodiments of the present invention as hereinbefore exemplified without departing from its scope defined in and by the appended claims.

1. An optical device for use in a monitoring system for monitoring at least one optical channel of an input multi-channel light signal, the device comprising: a light splitting assembly for splitting the input light signal into a predetermined number of light components; a predetermined number of tunable wavelength-selective filters each for filtering light of a specific optical channel from the light component passing therethrough; and the predetermined number of receivers, each associated with the corresponding one of said filters and operating to detect the filtered light and generate an output signal indicative thereof; the device thereby enabling processing of the output signals by an electronic assembly to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

2. The device according to claim 1, comprising a control unit operable for tuning the optical channel of each of the filters.

3. The device according to claim 1, wherein the light splitting assembly comprises a polarization splitter for splitting the input light into the pair of light components of orthogonal polarizations.

4. The device according to claim 1, wherein the light splitting assembly comprises a polarization splitting arrangement and a power splitting arrangement operating together to split the input light signal into said predetermined number of spatially separated light components, forming the light components of a first group having one linear polarization and the light components of a second group having the other linear polarization.

5. The device according to claim 4, wherein the polarization splitting arrangement comprises a single polarization splitter for splitting the input light into two light portions of orthogonal polarizations, and the power splitting arrangement comprises two power splitters accommodated in optical paths of said two light portions for splitting them into said predetermined number of light components.

6. The device according to claim 1, wherein the light splitting assembly comprises a power splitter for splitting the input light signal into two spatially separated light portions, and two polarization splitters each for splitting each of said light portions into two light components of orthogonal polarizations.

7. The device according to claim 3, comprising a pair of said filters optimized for processing light of different linear polarizations, respectively, and a pair of said receivers associated with said filters, respectively.

8. The device according to claim 4, comprising two pairs of said filters and two pairs of said receivers associated with said filters, respectively, wherein the filters of one pair are optimized for processing light of one linear polarization, and the filters of the other pair are optimized for processing light of the other linear polarization, all the filters being tuned to the same optical channel such that the filters of each pair have spaced-apart central wavelengths, each pair of the filters with its corresponding pair of the receivers thereby forming a wavelength discriminator unit, the device thereby enabling for subtracting the output of one receiver in the pair from that of the other receiver in said pair.

9. The device according to claim 4, comprising first and second group of said filters optimized for processing light of different linear polarizations, respectively.

10. The device according to claim 9, wherein the filters of each of the first and second groups are arranged in pairs such that the filters of each pair are tunable to the same optical channel and have spaced-apart central wavelengths, each pair of the filters with its corresponding pair of the receivers thereby forming a wavelength discriminator unit, the device thereby enabling for subtracting the output of one receiver in the pair from that of the other receiver in said pair.

11. The device according to claim 1, wherein the filters are arranged in a cascaded manner, such that the light component processed by one of the filters is an output light signal of the preceding filter in the cascaded array containing optical channels except for the optical channel filtered by said preceding filter.

12. The device according to claim 1, wherein the light splitting assembly includes an additional wavelength-selective tunable filter, which, while filtering from the input light a light signal of a specific channel to which said additional filter is tuned, splits the input light signal into the two light components, the first light component containing said light signal of the specific channel, and the second light component containing a remaining portion of the input light signal that propagates towards a first filter from said predetermined number of filters.

13. The device according to claim 12, comprising an additional receiver for detecting said first light component filtered by said additional filter.

14. The device according to claim 1, wherein said light splitter assembly operates to split the input light signal into N said light components, and the filters are arranged in an array of N filters, each for filtering a specific optical channel different from those of the other filters, the device being thereby operable to monitor N optical channels of an input light signal.

15. The device according to claim 1, wherein said light splitting assembly comprises a polarization splitter for splitting the input light signal into two light portions of orthogonal polarizations, respectively, and comprises two power splitters each accommodated in optical path of the respective one of said two light portions for splitting it into N light components to propagate towards N of said filters, respectively; and said filters comprises the filters of first and second group optimized for processing light of different linear polarizations, respectively, the device being thereby operable to monitor N optical channels of an input light signal.

16. The device according to claim 1, wherein said light splitter assembly operates to split the input light signal into N light components, thereby producing N/2 pairs of said light components; said filters include N filters arranged in N/2 pairs of filters, such that the filters of each pair are tunable to the same optical channel and have spaced-apart central wavelengths, each pair of filters with its corresponding pair of receiver presenting a wavelength discriminator unit; the device thereby providing for monitoring N/2 optical channels of the input light.

17. The device according to claim 1, wherein:
said light splitting assembly comprises a polarization splitter for splitting the input light signal into two light portions of orthogonal polarizations, respectively, and comprises two power splitters each accommodated in optical path of the respective one of said two light portions for splitting it into N light components thereby producing N/2 pairs of said light components;
said filters include N filters of a first group optimized for processing light of one linear polarization and N filters of a second group optimized for processing light of the other linear polarization;
the filters of each group are arranged in N/2 pairs of filters, such that the filters of each pair are tunable to the same optical channel and have spaced-apart central wavelengths, each pair of filters with its corresponding pair of receivers presenting a wavelength discriminator unit.

18. The device according to claim 1, wherein the filter includes at least one of the following structures: a ring resonator based filter, a tunable fiber Bragg grating, a tunable micromechanical optical filter, a tunable Fabri-Perot, and a tunable thin film filter.

19. An optical device for use in a monitoring system for monitoring at least one optical channel of an input multi-channel light signal, the device comprising:
a light splitting assembly for splitting the input light signal into at least one pair of light components;
at least one pair of tunable wavelength-selective filters, the paired filters being tunable for the same optical channel, for filtering light of said optical channel from the light components passing therethrough, and having spaced-apart central wavelengths;
at least one pair of receivers, each receiver being associated with the corresponding one of the filters and operating to detect the filtered light and generate an output signal indicative thereof;
the device thereby enabling processing of the output signals by an electronic assembly by subtracting for each pair of receivers, the output signal of one receiver from that of the other receiver of said pair, to determine at least one of the following: central frequency of the filtered optical channel, power of the filtered optical channel, signal to noise ratio of the detected optical channel, eye pattern within said optical channel; bit error rate extraction; relative timing jitter of orthogonal polarizations of the filtered optical channel, and Polarization Mode Dispersion (PMD) of the filtered optical channel.

20. An optical device for use in a monitoring system for monitoring at least one optical channel of an input multi-channel light signal, the device comprising:
a light splitting assembly including a polarization splitting arrangement and a power splitting arrangement operating together to split the input light signal into a predetermined number of spatially separated light components, forming the light components of a first group having one linear polarization and the light components of a second group having the other linear polarization;
the predetermined number of tunable wavelength-selective filters each for filtering light of a specific optical channel from the light component passing therethrough, said filters comprising the filters of a first group optimized for processing light of one linear polarization, and the filters of a second group optimized for processing light of the other linear polarization; and
the predetermined number of receivers, each associated with the corresponding one of said filters and operating to detect the filtered light and generate an output signal indicative thereof;
the device thereby enabling processing of the output signals by an electronic assembly to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

21. An optical device for use in a monitoring system for monitoring at least one optical channel of an input multi-channel light signal, the device comprising:
a light splitting assembly comprising a polarization splitter for splitting the input randomly polarized light signal into two light components of orthogonal polarizations, respectively;
two tunable wavelength-selective filters optimized for processing light of different linear polarizations, respectively, and tunable for the same optical channel of the input light signal for filtering light of said optical channel from the light components passing therethrough, respectively;
two receivers, each associated with the corresponding one of said filters and operating to detect the filtered light and generate an output signal indicative thereof;
the device thereby enabling monitoring of multiple channels of the input light signal by retuning the filters from channel to channel, and enabling processing of the output signals by an electronic assembly to determine at least one of the following: central frequency of the filtered optical channel, power of the filtered optical channel, a signal to noise ratio of the detected optical channel, eye pattern within the filtered optical channel; bit error rate extraction; relative timing jitter of orthogonal polarizations of the filtered light channel, and Polarization Mode Dispersion (PMD) of the filtered optical channel.

22. An optical device for use in a monitoring system for monitoring at least one optical channel of an input multi-channel light signal, the device comprising:
a light splitting assembly comprising a polarization splitting arrangement and a power splitting arrangement operating together to split the input light signal into two pairs of spatially separated light components;
two wavelength discriminator units, each wavelength discriminator unit comprising a pair of tunable wavelength-selective filters each for filtering light of a specific optical channel to which the filter is tuned from the light component passing therethrough, and comprising a pair of receivers associated with said pair of filters, respectively, and operating to detect the filtered light and generate two output signal indicative thereof, all the filters being tunable to the same optical channel, such that the filters of each pair have spaced-apart central wavelengths;
the device thereby enabling processing of the output signals by an electronic assembly to determine at least one of the following: a central frequency of the optical channel to which the filters are tuned, a power of said optical channel, a signal to noise ratio of the detected optical channel, eye pattern within said optical channel; bit error rate extraction; relative timing jitter of orthogonal polarizations of said light channel, and Polarization Mode Dispersion (PMD) of said optical channel.

23. An optical device for use in a monitoring system for monitoring N optical channels of an input multi-channel light signal, the device comprising:
a light splitting assembly comprising polarization splitting arrangement and a power splitting arrangement operating together to split the input light signal into 2N spatially-separated light components including N light components of a first group having one linear polarization and N light components of a second group having the other linear polarization;
an array of N wavelength discriminator units for processing said N optical channels, respectively, each wavelength discriminator unit comprising: a pair of tunable wavelength-selective filters each for filtering, from the light component passing therethrough, light of a specific optical channel different from those of the other channels, the filters of each pair having spaced-apart central wavelengths, and comprising a pair receivers associated with said pair of filters, respectively, and operating to detect the filtered light and generate two output signal indicative thereof;
the device thereby enabling processing of the output signals by an electronic assembly to subtract the output of one receiver of the discriminator unit from the output of the other receiver of said discriminator unit, and obtain data indicative of at least one of the following: central frequency of each of the N optical channels, a power of each of the N optical channels, a signal to noise ratio in each of the detected optical channels, eye pattern within each of the N optical channels; bit error rate extraction; relative timing jitter of orthogonal polarizations of each of the N optical channels, and Polarization Mode Dispersion (PMD) of each of the N optical channels.

24. A system for monitoring at least one specific optical channel of an input multi-channel light signal, the system comprising the optical device of claim 1, and an electronic assembly operable to receive the outputs of the receivers and carry out said subtraction.

25. A system for monitoring optical channels of an input multi-channel light signal, the system comprising an optical device and an electronic assembly connectable to the optical device, wherein:
the optical device comprises: a light splitting assembly for splitting the input light signal into a predetermined number of light components; a predetermined number of tunable wavelength-selective filters each for filtering light of a specific optical channel from the light component passing therethrough; and the predetermined number of receivers, each associated with the corresponding one of said filters and operating to detect the filtered light and generate an output signal indicative thereof,
the electronic assembly operates to process the output signals to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

26. A method for use in monitoring at least one optical channel of an input multi-channel light signal, the method comprising:
(i) splitting the input light signal into a predetermined number of light components;
(ii) passing the light components through the predetermined number of tunable wavelength-selective filters, respectively, to thereby filter from each of the light components a light signal of a specific optical channel;
(iii) detecting the filtered light signals by the predetermined number of receivers, respectively, to thereby generate the predetermined number of output signal indicative of the detected light signals;
the method thereby enabling processing the output signals by an electronic assembly to determine at least one of the following: a central frequency of at least one optical channel of the input light signal, a power of at least one optical channel of the input light signal, a signal to noise ratio of at least one detected optical channel, eye pattern within at least one optical channel of the input light signal; bit error rate extraction; relative timing jitter of orthogonal polarizations of at least one light channel of the input light signal, and Polarization Mode Dispersion (PMD) of at least one optical channel of the input light signal.

27. The method according to claim 26, wherein said splitting comprises splitting the randomly polarized multi-channel light signal into two light portions of orthogonal polarizations, and applying power splitting to each of said two light portions to thereby obtain said predetermined number of the light components.

28. The method according to claim 26, wherein said splitting comprises splitting the randomly polarized multi-channel light signal into spatially separated light portions and splitting each of said light portions into two light components of orthogonal polarizations.

29. The method according to claim 26, comprising sequentially retuning at least some of the filters to thereby sequentially monitor multiple channels of the input light.

30. The method according to claim 26, comprising tuning each of the filters to an optical channel different from that of the other filters, thereby concurrently monitoring multiple channels of the input light.

31. The method according to claim 26, comprising tuning at least one pair of filters to the same optical channel with a center frequency of one filter in the pair being spaced-apart from that of the other filter in said pair.
